(19) United States
(12) Patent Application Publication
(10) Pub. No.: US 2008/0205389 A1
(43) Pub. Date: Aug. 28, 2008

(54) Selection of transrate and transcode processes by host computer

(75) Inventors: Nicholas J. Fang, Redmond, WA (US); Todd Z. Bowra, Redmond, WA (US); Ashley C. Speicher, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/710,762

(22) Filed: Feb. 26, 2007

(51) Int. Cl. H04L 12/28

(52) U.S. Cl. 370/389

(57) ABSTRACT

A host computer manages and processes multiple requests for transmission of media content to other devices within a network. Hardware or software-driven media processing units format media content for streaming to the network devices. A policy engine manages processing constraints of the media processing units to determine the best combination of transrate/transcode processes to provide the highest quality transmissions without overloading the processing capacity of the host computer. The policy engine also considers available network bandwidth when determining transformation instructions for the media processing units. The policy engine identifies target formats, bit rates, and image resolutions for output for each media stream or for storage for later transmission and instructs the media processing units to transrate and/or transcode the media content appropriately to meet the demand.

### BACKGROUND

Many consumers are integrating formerly independent media presentation systems into a network under central control of a multimedia personal computer (PC) acting as a host and having the ability to share media files by streaming the media among the various devices connected to the network. Home networks predominantly use wireless technology, which often has unpredictable bandwidth throughput, causing quality of service issues for media streaming, particularly when high definition or otherwise high bit rate content is involved. Also, the devices on the network are inconsistent in the media format and bit rate of media streams that they can support. Thus, the original format of media content supplied by the host PC may need to be transformed into different formats or bit rates for reception by a particular network device.

While more devices may be added to the network, the processing resources of the host PC generally remain static. In media server systems, the host PC may be equipped with a dedicated media processing chip to perform transcoding and transrating operations on media streams. In some configurations, the host PC may include software to harness the processor or a media card on the host PC to perform transcode or transrate functions to change the format or bit rate of media files stored on the host PC. However, at some point, there is a finite limit on the processing power of the host PC to meet the demand for media content in desired formats and transfer rates that may be requested by the network devices.

### SUMMARY

The technology described herein allows a host PC or other computer functioning as a media server to manage and process multiple requests for transmission of content to other devices within a network. The media server may have special purpose processor chips for encoding/decoding and/or compressing/decompressing the format of media content and/or may have a software module that may direct the general processor or a graphics card of the PC to perform these functions. These hardware or software driven “media processing units” in the media server may be used to format content streamed to various media receivers to fulfill the requests of the connected devices. The media processing units may be controlled by a policy engine that manages processing constraints of the media server and determines the best combination of transrate/transcode processes for the combination of media files and corresponding output streams that provides the highest quality transmissions without overloading the processing capacity of the media server. The policy engine also enables media streaming to all requesting devices across the network where otherwise there would be insufficient bandwidth to support the source content (by transrating or transcoding the media file before transmission to reduce bandwidth requirements) and/or to requesting devices that do not support the source media format (by transrating or transcoding the source media content to a supported bit rate or format).

In the event that hardware media processing resources are fully allocated before all requests for media content processing can be satisfied, the policy engine may be used to select processing options or reallocate processing resources for greater efficiency in order to increase the number of requests that can be processed, increase the speed of the processing, or to reorder the processing to best serve current needs. The policy engine may determine whether software-based decoding/encoding is an option. The policy engine may base its determination on a variety of factors including, for example, the processing capacity of the media server, the network bandwidth, the capabilities of the media receiving devices, image quality, device requests, user priorities, and storage capacity. The policy engine may then identify target formats, bit rates, image resolutions, and other measures of quality of the media output for each media stream or for storage for later transmission and instruct the media processing units on the media server to transrate and/or transcode the media content appropriately to meet the demand. In the case of non-real-time transrating/transcoding, hardware and software decode/encode operations can occur in the background or during off-peak periods.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

FIG. 1 is a schematic diagram of an exemplary home media system including a media server configured to service content requests from multiple client media receivers by managing transrate and transcode resources.

FIG. 2 is a schematic diagram of representative components of an exemplary media system providing host transrate and transcode processing for distribution of media content to multiple media receivers.

FIG. 3 is a flow diagram of an implementation for determining transrate and transcode functions that can be performed within the processing limits of the media server and network environment.

FIG. 4 is an exemplary schema of input parameters for a policy engine that manages the transrate and transcode functions of a media server and output parameters that determine the transrate and transcode functions performed on media content requested at a particular media receiver.

FIG. 5 is a flow diagram of an implementation of a codec resource allocation scheme for determining efficient processing configurations for a number of media streams.

FIG. 6 is a schematic diagram of an exemplary general purpose computing system that may take the form of one or more of the devices in an implementation of a media system described herein.

### DETAILED DESCRIPTION

A given media processing unit (MPU) has finite capabilities that will be surpassed if a great enough number of simultaneous operations is requested. For example, one MPU may only support two paired encode and decode operations. This limits the functionality of the MPU, e.g., to recording two TV shows, recording one TV show while watching another, or recording one TV show while transcoding another. As a result, conflicts will invariably arise due to competition for these resources. As used herein, the term “media processing unit” or “MPU” refers to any hardware chipset codecs, hardware-assisted codecs, or a central processing unit (CPU) or graphics processing unit (GPU) (e.g., a graphics card) under the control of a software module that provides transformative processing operations to media files or media streams.

MPUs may possess several processing characteristics. A first characteristic may be support for real-time media encoding into at least one media format, e.g., Motion Picture Experts Group 2 (MPEG-2) or Windows Media Video (WMV). A second characteristic may be support for real-time media decoding from at least one media format (e.g., MPEG-2 or WMV). Another characteristic may be chained operation of decode followed by encode, which may either be transrating (if the reencoded format matches the source format but the bit rate is changed) or transcoding (if the reencoded format differs from the source format).

As used herein, the term “codec” is a portmanteau of either or both “coder-decoder” and “compressor-decompressor,” and describes a device or program capable of performing transformations on a data stream or signal. Codecs can transform the stream or signal into an encoded and/or compressed format (e.g., for transmission, storage, or encryption) and also decode and/or decompress that format for viewing or manipulation in a format more appropriate for these operations. As used herein, “transrate” refers to a process of decoding a media stream input at a first bit rate and re-encoding the media stream as an output at a second bit rate. As used herein, “transcode” refers to a process of decoding a media stream input in a first format and re-encoding the media stream as an output in a second format. Transrate and transcode operations may be performed by codecs or other MPUs. Additionally, as used herein, “transformative” or “transformation” processing operations refer to processes for encoding, decoding, compressing, decompressing, transrating, and transcoding media streams.

An exemplary MPU operation may include offline file transrating/transcoding, e.g., file decompression and recompression in a different compression format or at a different bit rate with the output saved to disk or other storage medium for later viewing. Another MPU operation may perform transformative processing to reduce the bit rate and enable network streaming of multimedia content from a media server to network-based media receivers to render the media content on an associated presentation device. A further MPU operation may perform real-time media encoding for capturing analog media streams (e.g., analog TV) for storage and later viewing. In one implementation the video may be scaled between the decode and encode operations. For example, a high definition (HD) video may be decoded, scaled to a standard definition (SD) resolution, and then re-encoded. Yet another operation may perform real-time media storage to allow users watching live TV to pause, restart, and reverse through the program.

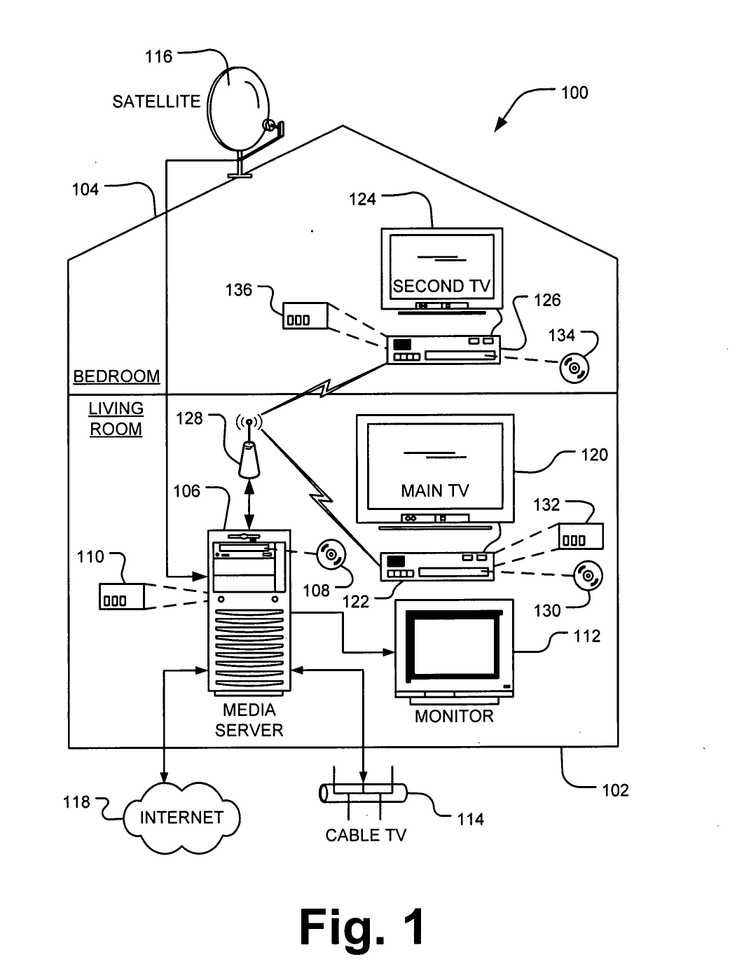

As indicated above, MPUs may be found as hardware or hardware/software combinations in devices connected within a networked media system. FIG. 1 depicts an exemplary home media system 100 including a living room 102 and a bedroom 104. Central to the media system 100 is a host computer in the form of a media server 106, in this implementation situated in the living room 102, but it could be located anywhere within the house. The media server 106 may dynamically adjust its media processing resources to meet the demands for distribution of media streams among media receivers 122, 126 within the media system 100. While FIG. 1 provides the example of a home media system 100, other systems and networks with a host computer are similarly considered for implementation of the technology described herein, for example, hotel, college, or corporate networks with multiple users accessing content from the Internet and hotel video on demand (VOD) systems.

In one implementation, the media server 106 may be a conventional personal computer (PC) configured to run a multimedia software package, for example, the Windows Vista® Ultimate operating system (Microsoft Corporation, Redmond, Wash. In such a configuration, the media server 106 may integrate full computing functionality with a complete home entertainment system into a single PC. For example, a user can watch television (TV) in one graphical window of a video monitor, while sending e-mail or working on a spreadsheet in another graphical window on the same monitor. In addition, the media server 106 may also include other features or components, for example: a personal video recorder (PVR) to capture live TV shows for future viewing or to record the future broadcast of a single program or series; a compact disc (CD) or digital video disc (DVD) drive 108 for disc media playback; a memory hard drive 110 for integrated storage of and access to a user's recorded content, such as TV shows, songs, pictures, and home videos; and an electronic program guide (EPG).

Instead of a conventional PC, the media server 106 may comprise a variety of other devices capable of storing and distributing media content including, for example, a notebook or portable computer, a tablet PC, a workstation, a mainframe computer, a computer server, an Internet appliance, or combinations thereof. The media server 106 may also be a set-top box capable of delivering media content to a computer where it may be streamed, or the set-top box itself could stream the media content. As the media server 106 may be a full function computer running an operating system, the user may also have the option to run standard computer programs (e.g., word processing and spreadsheets), send and receive e-mails, browse the Internet, or perform other common functions.

In addition to storing media content, the media server 106 may be connected with a variety of media sources, for example, a cable connection 114, a satellite receiver 116, an antenna (not shown for the sake of graphic clarity), and/or a network such as the Internet 118. A user may thus control a live stream of media content (e.g., TV content) received, for example, via the cable connection 114, the satellite receiver 116, or antenna. This capability is enabled by one or more tuners residing in the media server 106. The one or more tuners may alternatively be located remote from the media server 106. In either case, the user may choose a tuner to fit any particular preferences. For example, a user wishing to watch both standard definition (SD) and high definition (HD) content may employ a tuner configured for both types of contents. Alternately, the user may employ a SD tuner for SD content and a HD tuner for HD content separately.

The media system 100 may also include one or more network devices functioning as media receivers 122, 126 placed in communication with the media server 106 through a network 128, for example, a local area network (LAN). In an exemplary embodiment, the media receivers 122, 126 may be a Media Center Extender device, for example, an Xbox 360™ (Microsoft Corporation, Redmond, Wash.). The media receivers 122, 126 may also be implemented as any of a variety of conventional media rendering or computing devices, including, for example, a set-top box, a television, a video gaming console, a desktop PC, a notebook or portable computer, a workstation, a mainframe computer, an Internet appliance, a handheld PC, an MP3 player, a cellular telephone or other wireless communications device, a personal digital assistant (PDA), or combinations thereof. Each of the media receivers 122, 126 may additionally have optical disc drives 130, 134, respectively, for media playback of compact discs (CD), digital video discs (DVD), high definition DVDs (HD-DVD), Blu-ray discs, or other optical media formats. Each of the media receivers 122, 126 may also have memory hard drives 132, 136, respectively, to allow the media receivers 122, 126 to function as a DVR. Furthermore, the media receivers 122, 126 may include a tuner as described above.

The network 128 may comprise a wired and/or wireless network, for example, cable, Ethernet, WiFi, a wireless access point (WAP), or any other electronic coupling means, including the Internet. The network 128 may enable communication between the media server 106, the media receivers 122, 126, and any other connected device through packet-based communication protocols, such as transmission control protocol (TCP), Internet protocol (IP), real-time transport protocol (RTP), and real-time transport control protocol (RTCP). Communications may be transmitted directly between devices over a LAN, or they may be carried over a wide area network (WAN), for example, the Internet 118.

One or more video display devices, for example a main TV 120 in the living room 102, a secondary TV 124 in the bedroom 104, and a video monitor 112 may be situated throughout the media system 100. These video display devices may be connected with the media server 106 via the network 128 either directly or via the media receivers 122, 126. As shown in the example of FIG. 1, the main TV 120 and the secondary TV may be coupled to the media receivers 122, 126 through conventional cables. The video monitor 112 may be coupled with the media server 106 directly via a video cable. The media server 106 and media receivers 122, 126 may also or alternatively be coupled with any of a variety of video and audio presentation devices. Media content including TV content may thus be supplied to each of the video display devices 120, 124 over the home network 128 from the media server 106 situated in the living room 104.

The media receivers 122, 126 may be configured to receive streamed media content, including video and TV content, from the media server 106. Media content, and particularly video and TV content, may be transmitted from the media server 106 to the media receivers 122, 126 as streaming media comprised of discrete content packets via any of the network protocols described above. The streamed media content may comprise digital video delivered via IP, SD, and HD content, including video, audio, and image files, decoded on the home network devices 122, 126 for presentation on the connected TVs 120, 124. The media content may further be “mixed” with additional content, for example, an EPG, presentation content related to the media content, a web browser window, and other user interface environments transmitted from the media server for output on the TVs 120, 124 or the monitor 112. Such additional media content may be delivered in a variety of ways using different protocols, including, for example, standard remote desktop protocol (RDP), graphics device interface (GDI), or hypertext markup language (HTML).

In addition to the media receivers 122, 126 and the video display devices 112, 120, 124, the media server 106 may be connected with other peripheral devices, including components such as digital video recorders (DVR), cable or satellite set-top boxes, speakers, and a printer (not shown for the sake of graphic clarity). The media server 106 and media receivers 122, 126 may also enable multi-channel output for speakers. This may be accomplished through the use of digital interconnect outputs, such as Sony-Philips Digital Interface Format (S/PDIF) or TOSLINK® enabling the delivery of Dolby Digital, Digital Theater Sound (DTS), or Pulse Code Modulation (PCM) audio.

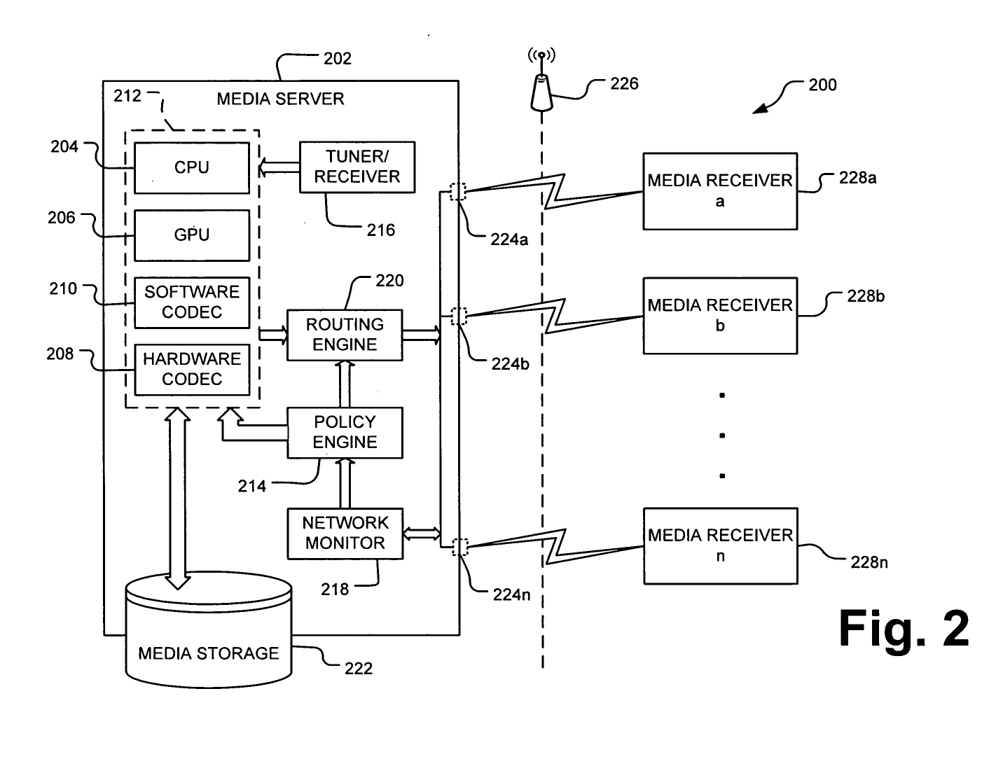

An exemplary implementation of a media system 200 is depicted in FIG. 2. The media system 200 may include a media server 202 as previously described with respect to FIG. 1. A media server 202 may include several components that are useful for performing transformative processing operations, including transrate and transcode operations on the media server 202. As shown in FIG. 2, the media server 202 may include a primary processor or CPU 204 and a separate graphics card, i.e., graphics processing unit (GPU) 206. The media server 202 may further be equipped with a hardware codec 208 for performing transrate and transcode functions to manage media requests from multiple media receivers 228a-n. Among the software modules stored on and operable upon the media server 202 may be a software codec 210, which may by instantiated to harness either the processor 204 or the GPU 206 to emulate the hardware codec 208 and process a media stream in a manner similar to the special function hardware codec 208 chip. In addition to the hardware codec 208, both the processor 204 and GPU 206 may be considered MPUs 212 when under control of the software codec 208.

Additional software modules resident on the media server 202 may include a policy engine module 214. The policy engine 214 is primarily responsible for directing transformative processing operations by the MPUs 212 by considering the processing costs of any local and network requests for media content, the available network bandwidth, and other factors discussed in greater detail below; picking the best combination of transformative operations based upon processing capacity; and allocating processing operations among available MPUs 212 on the media server 202. Further software components resident on the media server 202 may include a network monitor module 218 and a routing engine module 220, whose functions will be described in greater detail below.

As indicated above with respect to FIG. 1, the media server 202 may receive programming and media content from a variety of sources including over-the-air broadcast, cable, satellite, and the Internet or other network connections. The media server 202 may be equipped with a receiver/tuner module 216 as shown in FIG. 2 to demodulate and digitize these programming signals for further processing by the MPUs 212 for streaming to requesting media receivers 228a-n over the network link 226. An additional component of the media server 202 may be a memory storage device 222 for storage of media files. As indicated by the overlap of the media storage device 222 with the bounds of the media server 202 in FIG. 2, the media storage device 222 may be internal or external to the media server 202. Note that media files may be stored elsewhere on other devices connected with the media server 202 within the media system 200, for example, a DVD or other optical drive or one or more media receiver devices 228a-n.

As shown in FIG. 2, the media server 202 may be connected with one or more media receiver devices 228a-n. As described with respect to FIG. 1, each media receiver 228a-n, may be connected with the media server 202 over a local network link 226, e.g., via a wireless network or an Ethernet connection. Alternatively, one or more of the media receivers 228a-n may be directly connected with the media server, for example, via a serial connection or a USB connection. The media receivers 228a-n may receive media content streamed from the media server 202 and then output such media content to an attached presentation device, for example, a television.

A network monitor module 218 may operate on the media server 202 to monitor data communication traffic over the network link 226 at various nodes 224a-n corresponding to each of the media receiver devices 228a-n representative of communications between the media receivers 228a-n and other devices on the network. The network monitor 218 passes real time network information to the policy engine 214, for example, the available bandwidth of the network link 226, the allocation of bandwidth between the media receivers 228a-n, hardware and software configuration information from the media receivers 228a-n, media requests from the media receivers 228a-n, and whether a particular media receiver 228a-n is active.

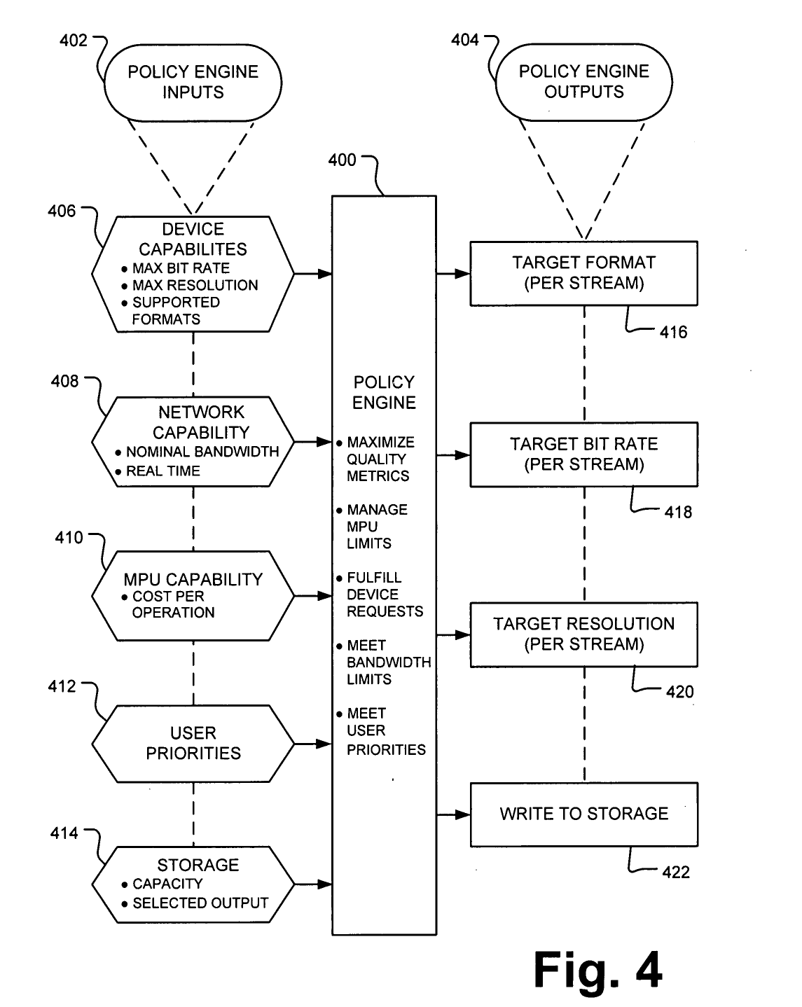

The policy engine 214 incorporates this network information into a decision making process to determine how to handle requests for media content, whether media content needs to be transformed (e.g., transrated or transcoded), which MPUs 212 to use to perform any transformations, and which media receivers 228a-n are to receive what output. Additional details of the policy engine considerations and output are discussed below with respect to FIG. 4. The policy engine 214 further provides direction to the routing engine 220, which allocates the media streams transformed by the MPUs 212 to the designated nodes 224a-n for the requesting or receiving media receivers 228a-n.

In one implementation, a function of the processor 204 of the media server 202 may be to manage the processing load allocation between hardware and software MPUs 212, including the processor 204 itself if functioning as a software-driven codec, according to the direction of the policy engine 214. In some configurations, the processor 204 may comprise multiple CPUs or processing cores that can process data independently. As part of this management function, the processor 204 may read media files from the media storage volume 222, transmit media files in a media stream to other devices such as the media receivers 228a-n for playback or local storage. In such an implementation, by allocating media stream codec functions to other MPUs 212 if available, the processing demands on the processor 204 may be reduced by having it perform fewer of the requested transformative processing operations on a media file.

The policy engine 214 may also allocate an MPU 212 to perform a media transrating or transcoding function at a future time or to run in the background when processing power is available. For example, a user may request that a media file be transrated or transcoded to a different media format for minimizing the required storage space of the file. Alternatively, the policy engine may recognize that a particular file is regularly requested and always requires a processing transformation. A reaction of the policy engine 214 may be to transform the media file and re-save it to storage 222 so that the next time the media file is requested, no transformative processing will be required. In each of these situations, there is no immediate need to process the media file. The policy engine 214 may determine based upon presently available network processing resources to delay such a processing operation until such time as real-time user demand has decreased, for example, in the middle of the night or in the background during periods of available processing power.

The policy engine 214 may be configured to maximize the utilization of hardware codecs, maximize the number of simultaneous operations that may be performed by MPUs, provide media stream output at the highest quality and bit rate processable by a given media receiver 228a-n processable at a given time, and automatically mitigate hardware and bandwidth control contentions. The policy engine 214 enables transrating/transcoding functionality to be intelligently shared by multiple users and applications at once with a goal of independently processing each request. The policy engine 214 dynamically allocates MPU 212 resources between competing requests to enable simultaneous execution of several operations in order to minimize the impact of contention between requests to the user. Furthermore, in the case where not all requests can be satisfied by the available resources, the policy engine 212 may determine an appropriate level of dependent processing to ensure that all requests for media are serviced, even if the output is not at the highest quality, preferred format, or highest bit rate preferred by a given media receiver 228a-n.

As used herein, “independent processing” refers to allocation by the policy engine 214 of transformative processing requests among any available MPUs 212 and provision of a media stream of transformed content to each media receiver 228a-n that meets all of the format, bit rate, and resolution quality requested by each particular media receiver 228a-n. As used herein, “dependent processing” refers to an allocation of resources by the policy engine 214 to perform transformative processing functions on media content to output a media stream to each requesting media receiver 228a-n that, while not meeting the requested or highest bit rate, quality, or format, ensures that a media stream is output to each requesting media receiver 228a-n in a format and bit rate that can be processed such that each media receiver 228a-n does not run out of data for processing (i.e., starve) and thus interrupt playback.

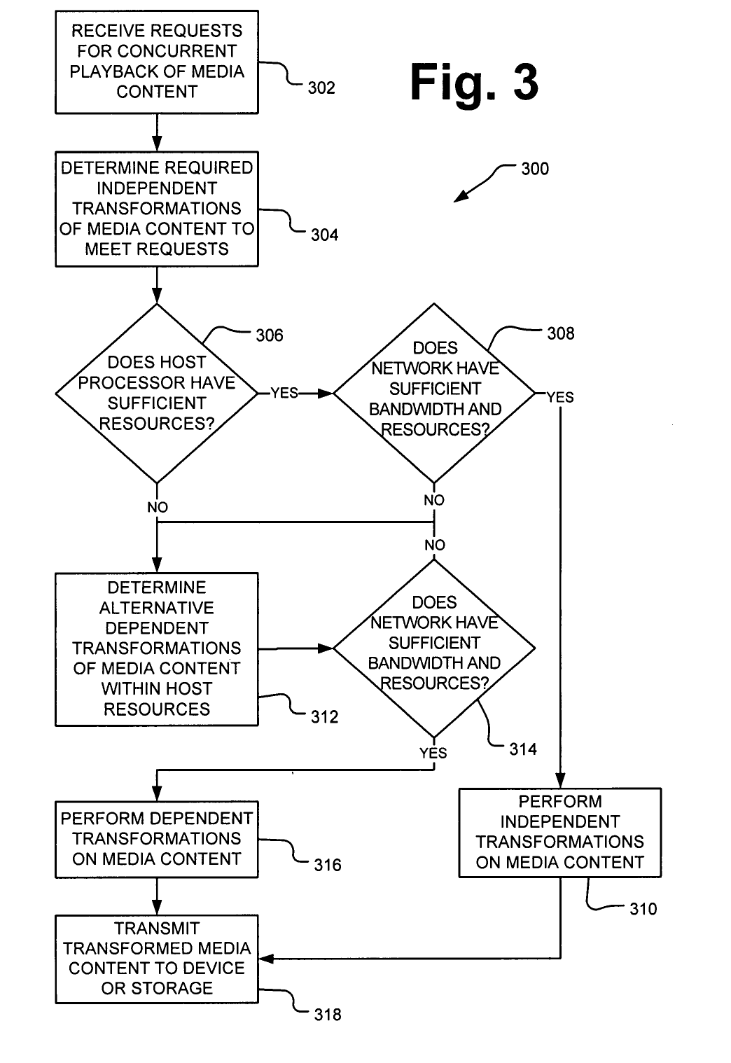

FIG. 3 depicts an exemplary process 300 that may be performed by the policy engine 214 to handle multiple competing requests for provision of media content. Initially, in a receiving operation 302, the policy engine 214 receives multiple requests for concurrent playback of media content from a plurality of the media receivers 228a-n. Such concurrent requests can lead to both server processing and network bandwidth contention problems. Thus, the policy engine 214 first determines what independent transformations of media content are necessary to meet all of the competing requests by media receivers 228a-n in the network or any other user processing requests in determination operation 304.

Once the nature of the independent transformations are understood by the policy engine 214, it determines whether there are sufficient processing resources within the available MPUs 212 to perform all of the independent processing transformations in decision operation 306. If the policy engine 214 determines that sufficient resources are available to simultaneously perform all independent transformations, then the policy engine 214 analyzes the information from the network monitor module 218 to make a further determination whether there is sufficient bandwidth to transmit all of the media streams resulting from the independent transformations in decision operation 308. The policy engine 214 also considers information known about the processing capabilities of the media receivers 228a-n. If there is sufficient bandwidth to transmit all of the media streams resulting from the determined independent transformations and adequate remote processing ability, then the policy engine 214 directs one or more of the MPUs 212 to perform the independent transformations on the media content in performance operation 310. Once the independent transformations have been made, the transformed media content is transmitted by the routing engine 220 over the network 226 to the various requesting media receivers 228a-n, or alternately is stored locally on the storage device 222, in transmission operation 318.

If in decision operation 306, the policy engine 214 determines that there is insufficient processing power in the media server 202 to make all of the necessary independent processing transformations to meet the requests, then the policy engine 214 determines possible alternate dependent transformations of media content that can be made within the available resources of the media server 202. For example, suppose two users request the same media content originally streaming at a bit rate of 6 Mbps and encoded in MPEG-4, but the first user device only supports MPEG-2 and a maximum bit rate of 2 Mbps and the second device, while supporting MPEG-4, has a maximum bit rate of 4 Mbps. The policy engine 214 could first consider two independent transformations, both transcoding the original media stream to MPEG-2 and transrating it to 2 Mbps to create a first new stream while also transrating the original media stream to 4 Mbps but retaining the MPEG-4 format to create a second new stream. Upon determination that there is insufficient processing power in the media server 202 to make both of these transformations, the policy engine 214 could alternately consider a dependent transformation, transrating the original media stream to 2 Mbps and also transcoding it to MPEG-2 whereby it could be played back by both user devices. The policy engine 214 will then determine which of the two transformation options the media server 202 can perform based upon the available MPU 212 resources.

Before directing the performance of any transformation operations, however, in decision operation 314 the policy engine 214 considers the information received from the network monitor module 218 to determine whether there is sufficient bandwidth in the network 226 to transmit any of the considered transformation options. The policy engine 214 also considers information known about the processing capabilities of the media receivers 228a-n. If there is adequate bandwidth and remote processing capability, the policy engine 214 will select the dependent transformation option in performance operation 316 that provides the highest quality media stream to each requesting device 228a-n or otherwise meets any user priorities set for the media system 200. If there is not adequate bandwidth and/or remote processing capability, the process 300 returns to determination operation 312 to determine additional dependent transformation options that take into consideration the bandwidth and media receiver 228a-n processing limitations of the media system 200. The process 300 may iterate in this fashion until an appropriate dependent transformation is determined that meets both processing and bandwidth considerations.

Similarly, if in decision operation 308, the policy engine 214 determines that there is insufficient bandwidth across the network link 226 to transmit all of the media streams resulting from the independent processing transformations requested, then the policy engine 214 determines possible dependent transformations of media content that can be made within the available resources of the media server 202 to meet the bandwidth limitations. For example, suppose two users request the same media content originally streaming at a bit rate of 6 Mbps and encoded in MPEG-4, but the network can only support 10 Mbps total. The policy engine 214 could direct that the original media stream be transrated to 5 Mbps for transmission to and playback on both devices to maintain the highest quality possible.

Once the policy engine 214 has determined which dependent transformations can be performed within the processing and bandwidth limitations of the media system 200, the policy engine 214 then directs the media server 202 to perform the appropriate dependent transformations on the media content in performance operation 316. Then, after the dependent transformations have been made, the transformed media content is transmitted by the routing engine 220 over the network 226 to the various requesting media receivers 228a-n, or alternately is stored locally on the storage device 222, in transmission operation 318.

FIG. 4 schematically depicts a relationship between the policy engine 400, which may be governed by multiple and at times competing objectives, and multiple potential inputs 402 that may be considered before returning multiple different outputs 404 to direct the processing of requested media streams. The policy engine 400 may direct transformative processing options designed to, for example, fulfill the media content requests of the receiver devices, manage the processing constraints of the MPUs, maximize the quality metrics of a transmission; and fulfill any user imposed directives or priorities. Transmission quality metrics may include transformation of media content into the best format and/or bit rate compatible with the media receivers. Another consideration may be based upon available bandwidth in the network and determination of an acceptable tradeoff between quality and bandwidth if necessary. The policy engine 400 may make choices based upon the capabilities of devices in the system, the capabilities of the MPUs, the available bandwidth, and the user priorities and balance these concerns to give the best quality experience to each user.

For example, the policy engine 400 may determine the fewest number of streams requiring processing in order to maximize the processing power of the MPUs. In another example, when two users at two separate receiver devices are watching the same stream and the corresponding receiver devices provide navigation options (e.g., pause, fast/slow play, fast/slow reverse play, seek, skip), the policy engine 400 may transform the original media stream into a common format and bit rate processable by both receiver devices and save the transformed media content to a storage device on the media server. In this way, the processing demands on the MPUs may be reduced as transformation processing occurs only once. Navigation functions requested by users retrieve media content from the storage device in an appropriate format, rather than requiring MPU processing of the original media content each time one of the users initiates a navigation function.

As shown in FIG. 4, the policy engine 400 may consider a variety of different input parameters 402. A first input 406 may be information about the capabilities of the various devices connected to the media server over the network. Such devices may be the media receivers of FIGS. 1 and 2 or they may be other devices, for example, other personal computers. Device capability information may include media encoding profiles supported by the device, for example, the maximum bit rate processable by the device, the compression/coding formats supported by the device (e.g., MPEG-2, MPEG-4, Windows Media Formats), the maximum resolution supported by the device decoder (e.g., HD vs. SD support), and the maximum resolution of an image that can be output at the device (e.g., whether an HD-TV or standard resolution display is attached to the receiver device).

For example, the policy engine 400 may recognize that a request for particular media stream is for playback on a high quality presentation device, e.g., a big screen TV or an HD-TV. Then the policy engine 400 may place an increased priority on high-quality (e.g., lossless, or without significant signal degradation) processing of a media stream designated for output on such a device. Alternatively, if a scheduling engine is aware that an output request originated from a lower quality device, for example, an analog TV or a black and white TV, it may place lower priority on the high-quality processing of independently processable segments of a media stream designated for output on such devices. As another option, the scheduling engine may provide instructions to the selected MPU to drop frames for output to a lower quality presentation device in order to increase capacity for competing processing requests of other media streams designated for output on higher quality media devices.

A second input parameter 408 may be the capability of the network in which the media server resides. Considerations may include information about the maximum bandwidth and speed of the network as well as real-time bandwidth measurements that may fluctuate due to transmission of data in addition to the requested media streams.

A third input parameter 410 may be the capability and capacity of the processing resources available on the media server. Exemplary considerations may include a determination of hardware availability and selection and management of the hardware and software MPUs for the most efficient processing allocation of the requested media streams. The policy engine 400 may also determine the cost per operation to perform the requested transformations to assist in the making the allocation determination.

A fourth input parameter 412 may be user priorities, other user inputs, or commands received at the media server with respect to a particular competing media stream. As an example, the policy engine 400 may monitor user input received from the media receivers receiving real-time media streams. Upon receipt of a user input command to pause or stop playback of a particular media stream, the policy engine may reallocate the processing resources instantaneously to provide priority processing to the other media streams. Later, upon receipt of a user input command to resume playback of the paused media stream, the scheduling engine may readjust the priority allocations among the real-time media streams in order to account for and accommodate the increased processing requirements.

As another example, the policy engine 400 may access information from the media system regarding users of particular devices connected within the media system. If it is known that a particular presentation device corresponding to a media receiver is primarily used by adults in a household, the policy engine 400 may prioritize the processing of requests to be output to that particular media receiver. Alternatively, if the profile information indicates that a particular presentation device is primarily used by children in a household, the policy engine 400 may decrease priority given to processing a media stream for output on such a presentation device.

A fifth input parameter 414 may be the amount of available storage capacity associated with the media server. Exemplary considerations may include whether the media stream needs to be processed for real-time output or whether the output is merely for archival storage purposes. If the media stream is designated for real-time output, then the policy engine 400 may increase the priority placed on processing the media stream. Alternatively, if an offline transcode or transrate operation is desired, e.g., for archival purposes or to reduce future load on the MPUs, which can be done in the background, then the policy engine 400 may remove the media content from consideration for immediate processing, transform the media content at a later time when demand on the MPUs has subsided, and store the transformed content on a storage device for later transmission.

The policy engine outputs 404 directing the processing functions of the MPUs may include a target media format output 416 for each output stream requested by the receiving devices, a target bit rate output 418 for each output stream, and a target image resolution output 420 for each output stream. These target outputs may be considered quality levels that should be met by the MPUs. With these output parameters, the policy engine 400 can effectively manage the functions of the MPUs to meet the quality needs of the requesting receiver devices. An additional storage write output 422 may indicate whether the transformed media content should be written to a storage device. As part of this storage write determination, the policy engine 400 may decide whether to process requested media content immediately or at a delayed or off-peak time, e.g., to reduce processing demands on regularly requested media content.

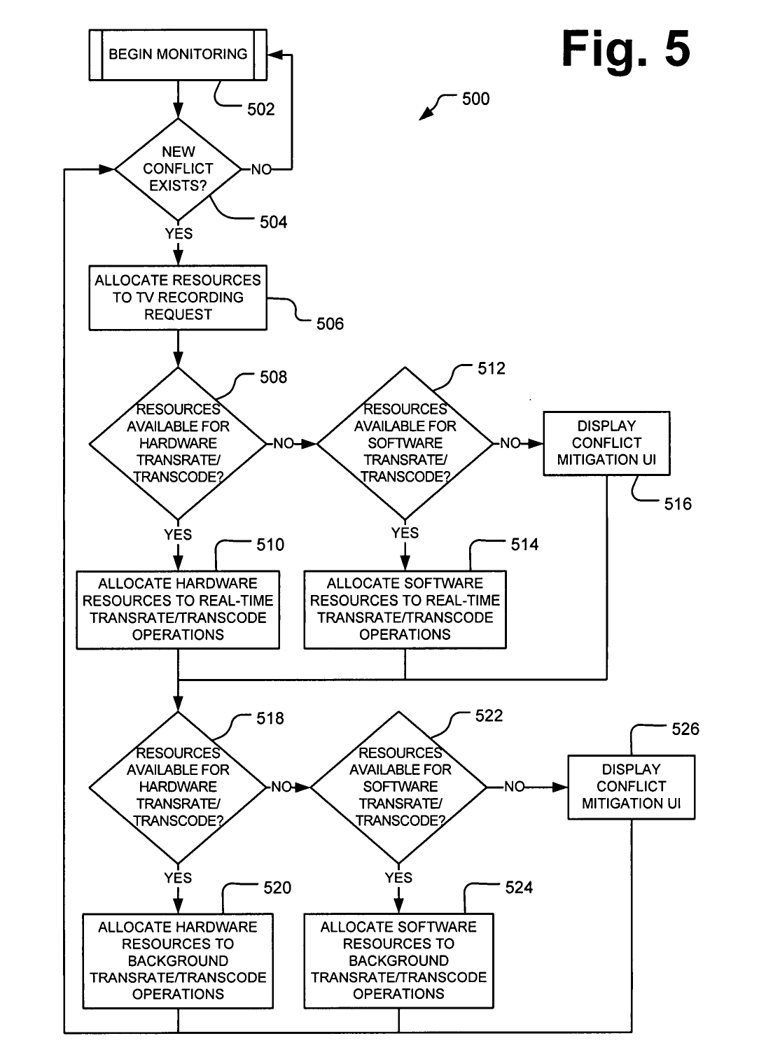

An exemplary implementation of processing load allocation of one or more MPUs within a media sever according to the exemplary list of inputs 402 to the policy engine 400 of FIG. 4 in order to generate appropriate output 404 for managing the MPUs is depicted in FIG. 5. The policy engine functions 500 begin with a monitoring operation 502 in which media processing requests of the media server are monitored to determine whether there are conflicts between requests due to a lack of MPU processing power. Thus, a conflict decision operation 504 may determine at a regular appropriate processing interval whether or not a new conflict exists. If the conflict decision operation 504 determines that there is no present conflict, then operation returns to the monitoring operation 502.

If it is determined that there is a processing conflict, a first allocation operation 506 allocates an MPU resource initially to any TV recording requests (e.g., through the tuner/receiver 216 in FIG. 2) as per the determination of the policy engine 400 of FIG. 4. For example, if a user has programmed the media server to record a weekly television show, the policy engine 400 may attempt to select the most efficient processing resource available within the media system in order to accommodate the television recording request. Generally the most efficient tuning and encoding processing operations typically required for recording a stream of media programming may be performed by a hardware MPU. If there are additional requests for real-time media stream processing beyond the TV recording request, e.g., streaming of a real-time TV broadcast, the policy engine 400 may determine how best to fulfill such additional requests with the resources available within the media server. Thus, the policy engine 400 may in a first resource decision operation 508 determine whether a hardware MPU resource is available for transrate or transcode functions.

If a hardware resource is available, the policy engine may in a second allocation operation 510 allocate the available hardware resource for the purpose of real-time transrate and transcode operations to present the live television program while simultaneously recording a second television show. In a further example, the policy engine may be aware that two users have requested that the same television show be recorded and the media receiver of the first user can only process a low bit rate media stream while a media receiver associated with the second user can process a higher bit rate stream. The policy engine 400 may in view of the available MPU capacity direct that the television program be transrated only once to the lower bit rate and stored for later playback by both users. Although the bit rate may be lower than optimal for the second media receiver, both users' requests have been fulfilled within the processing limitations of the media server. In an alternative implementation, the policy engine 400 could direct that the MPU transcode the television show into a scalable format in which multiple bit rates are provided in the same file so that each of the media receivers associated with the two users can be presented a media stream with an optimal bit rate.

If in the first resource decision operation 508 the policy engine 400 finds that a hardware resource is not available for processing the real-time requests in addition to the TV recording request, a second resource decision operation 512 may determine whether processing resources are available for a software-implemented transrate and/or transcode process for such additional real-time requests. If a software MPU is available, the policy engine 400 may allocate software and processor resources to perform the real-time transrate/transcode operations in order to meet the live TV presentation request in the third allocation operation 514.

Alternatively, if no software MPU resources are determined to be available in resource decision operation 512, a UI presentation operation 516 may present a UI to the user identifying the conflict and requesting user input to determine how to mitigate the conflict. Such a request of the user may require that the user identify which of the several competing priorities for media stream processing should take precedence. In an alternate implementation, the policy engine 400 may be configured to make a default choice or best decision under the circumstances instead of allowing the user to manage the conflict.

Once any hardware or software MPUs have been allocated in operations 510 and 514 for real-time processing, or alternatively, the user has made a selection to mitigate any conflicts via the UI presentation operation 516, the policy engine 400 may next determine whether there are any available processing resources within the media server to handle any lesser priority processing requests. In a third resource decision operation 518, the policy engine 400 may first determine whether there are any hardware MPU resources available for processing the lower priority media streams that are not requests for real-time recording playback. If the third resource decision operation 518 determines that there are adequate hardware resources to perform transrate or transcode operations in the background to any primary processing needs, the policy engine 400 may allocate the hardware in a fourth allocation operation 520.

Alternatively, if the policy engine 400 finds that hardware resources are not available or sufficient for processing the background requests, a fourth resource decision operation 522 may determine whether processing resources are available for a software-implemented transrate and/or transcode process for such additional background requests. If a software MPU is available, the policy engine 400 may allocate software and processor resources to perform the background transrate/transcode operations in order to meet the lower priority request in a fifth allocation operation 524.

However, if in the fourth resource decision operation 522 it is determined that there is no processing capacity to allow for a software MPU to process the lower priority media streams, a conflict mitigation Ul may be displayed in display operation 526 thereby allowing the user to choose from among the desired media processing operations and manually allocate priority. In an alternate implementation, the policy engine 400 may be configured to make a default choice or best decision under the circumstances instead of allowing the user to manage the conflict. Once all the necessary allocation operations have been performed according to direction of the policy engine 400, the policy engine 400 may return to the conflict decision operation 504 to continue to monitor for conflicts in resource allocation and to iteratively maximize the use of hardware and software MPU resources.

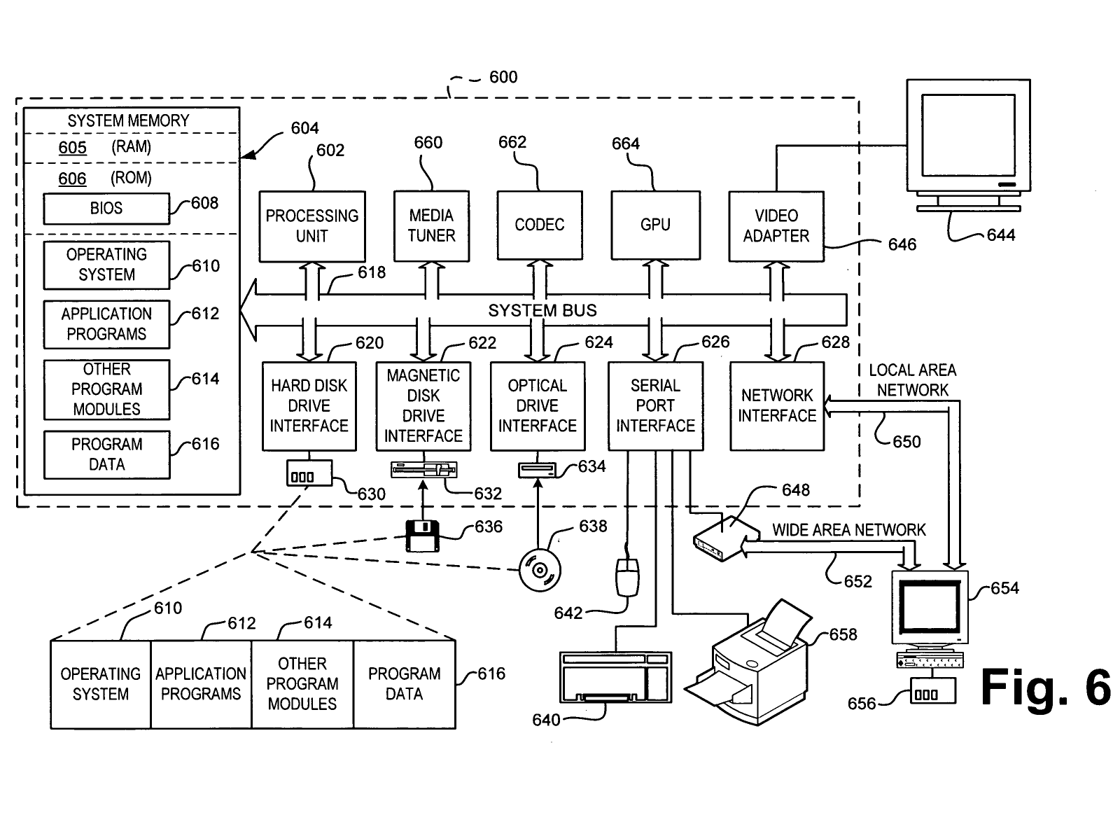

FIG. 6 depicts exemplary hardware and an operating environment for implementing the technology described herein. The media server, media receivers, and other devices within the media network may be generally described as general purpose computing devices in the form of a computer 600, including a processing unit 602, a system memory 604, and a system bus 618 that operatively couples various system components, including the system memory 604 to the processing unit 602. There may one or more processing units 602, such that the processing functions of the computer 600 are performed by a single central processing unit (CPU), or a plurality of processing units, commonly referred to as a parallel processing environment. Processing functions may also be performed by a dedicated codec card 662, a GPU 664, or other MPU in the computer, which are also connected with the system bus 618 for control by the processing unit 602. The computer 600 may be a conventional computer, a distributed computer, or any other type of computer.

The system bus 618 may be any of several types of bus structures including a memory bus or memory controller, a peripheral bus, a switched fabric bus, point-to-point connections, and a local bus using any of a variety of bus architectures. The system memory 604 may also be referred to as simply the memory, and includes read only memory (ROM) 606 and random access memory (RAM) 605. A basic input/output system (BIOS) 608, containing the basic routines that help to transfer information between elements within the computer 600, such as during start-up, is stored in ROM 606. The computer 600 may further include a hard disk drive 630 for reading from and writing to a hard disk, a magnetic disk drive 632 for reading from or writing to a removable magnetic disk 636, and an optical disk drive 634 for reading from or writing to a removable optical disk 638 such as a CD ROM, DVD, or other optical media.

The hard disk drive 630, magnetic disk drive 632, and optical disk drive 634 are connected to the system bus 618 by a hard disk drive interface 620, a magnetic disk drive interface 622, and an optical disk drive interface 624, respectively. The drives and their associated computer-readable media provide nonvolatile storage of computer-readable instructions, data structures, program modules and other data for the computer 600. It should be appreciated by those skilled in the art that any type of computer-readable media that can store data that is accessible by a computer, for example, magnetic cassettes, flash memory cards, digital video disks, RAMs, and ROMs, may be used in the exemplary operating environment.

A number of program modules may be stored on the hard disk 630, magnetic disk 636, optical disk 638, ROM 606, or RAM 605, including an operating system 610, one or more application programs 612, other program modules 614, and data 616. In an exemplary implementation, the policy engine module, the network monitor module, the routing engine module, and any software MPU may be incorporated as part of the operating system 610, application programs 612, or other program modules 614.

A user may enter commands and information into the personal computer 600 through input devices such as a keyboard 640 and pointing device 642, for example, a mouse. Other input devices (not shown) may include, for example, a microphone, a joystick, a game pad, a tablet, a touch screen device, a satellite dish, a scanner, a facsimile machine, and a video camera. These and other input devices are often connected to the processing unit 602 through a serial port interface 626 that is coupled to the system bus 618, but may be connected by other interfaces, such as a parallel port, game port, or a universal serial bus (USB).

A monitor 644 or other type of display device may also be connected to the system bus 618 via an interface, such as a video adapter 646. In addition to the monitor 644, computers typically include other peripheral output devices, such as a printer 658 and speakers (not shown). These and other output devices are often connected to the processing unit 602 through the serial port interface 626 that is coupled to the system bus 618, but may be connected by other interfaces, such as a parallel port, game port, or a universal serial bus (USB). A media tuner module 660 may also be connected to the system bus 618 to tune audio and video programming (e.g., TV programming) for output through the video adapter 646 or other presentation output modules.

The computer 600 may operate in a networked environment using logical connections to one or more remote computers, such as remote computer 654. These logical connections may be achieved by a communication device coupled to or integral with the computer 600; the computer 600 is not limited to a particular type of communications device. The remote computer 654 may be another computer, a server, a router, a network personal computer, a client, a peer device, or other common network node, and typically includes many or all of the elements described above relative to the computer 600, although only a memory storage device 656 has been illustrated in FIG. 6. The logical connections depicted in FIG. 6 include a local-area network (LAN) 650 and a wide-area network (WAN) 652. Such networking environments are commonplace in office networks, enterprise-wide computer networks, intranets, and the Internet, which are all types of networks.

When used in a LAN 650 environment, the computer 600 may be connected to the local network 650 through a network interface or adapter 628, e.g., Ethernet or other communications interfaces. When used in a WAN 652 environment, the computer 600 typically includes a modem 648, a network adapter, or any other type of communications device for establishing communications over the wide area network 652. The modem 648, which may be internal or external, and which may operate over a standard telephone line, a digital subscriber line (DSL), a subscription cable system, or other communication network, is connected to the system bus 618 via the serial port interface 626. In a networked environment, program modules depicted relative to the personal computer 600, or portions thereof, may be stored in a remote memory storage device. It is appreciated that the network connections shown are exemplary and other means of and communications devices for establishing a communications link between the computers may be used.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understand that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is

1. A method in a host computer for developing transformation processing operations to optimize media content playback across multiple playback devices connected with the host computer in a network, the method comprising
receiving requests from the multiple devices for concurrent playback of media content at a first quality level;
determining a set of independent transformations of the media content that fulfill the requests at the first quality level;
if transformations are required, determining whether processing resources available on the host computer are sufficient to perform the independent transformations; and
if the processing resources are insufficient to perform the independent transformations, determining a set of dependent transformations that fulfill the requests at a second quality level within limits of the processing resources of the host computer.

2. The method of claim 1, wherein if the processing resources available on the host computer are sufficient to perform the independent transformations, the method further comprises performing the independent transformations.

3. The method of claim 1, further comprising performing the dependent transformations.

4. The method of claim 2 further comprising
monitoring available bandwidth of the network;
determining whether a requested set of media streams resulting from the independent transformations is transmissible within the available bandwidth of the network; and
if the requested set of media streams is not transmissible within the available bandwidth of the network, determining the set of dependent transformations such that a modified set of media streams resulting from the set of dependent transformations is transmissible within the available bandwidth of the network.

5. The method of claim 3 further comprising
monitoring available bandwidth of the network;
determining whether a modified set of media streams resulting from the dependent transformations is transmissible within the available bandwidth of the network; and
if the modified set of media streams is not transmissible within the available bandwidth of the network, determining a revised set of dependent transformations such that a revised set of media streams resulting from the revised set of dependent transformations is transmissible within the available bandwidth of the network.

6. The method of claim 1 further comprising
determining capabilities of the playback devices for processing a media stream;
determining whether the capability of each of the playback devices is sufficient to process a requested media stream resulting from the independent transformations; and
if not, determining whether the capability of each of the playback devices is sufficient to process a requested media stream resulting from the dependent transformations.

7. The method of claim 1, wherein the second quality level is lesser than the first quality level.

8. The method of claim 1, wherein the quality level is measured in terms of one ore more of the following: a selected format of the media content, a selected bit rate of the media content, and an image resolution of the media content.

9. A computer-readable medium having computer-executable instructions for performing a computer process implementing the method of claim 1.

10. A method in a host computer for developing transformation processing operations to optimize media content playback across multiple playback devices connected with the host computer in a network, the method comprising
receiving requests from the multiple devices for concurrent playback of media content at a first quality level;
determining a set of independent transformations of the media content that fulfill the requests at the first quality level;
determining whether processing resources available on the host computer are sufficient to perform the independent transformations; and
if the processing resources available on the host computer are sufficient to perform the independent transformations, performing the independent transformations to create a requested set of media streams;
if the processing resources are insufficient to perform the independent transformations, determining a set of dependent transformations that fulfill the requests at a second quality level within limits of the processing resources of the host computer; and
performing the dependent transformations to create a modified set of media streams; and
transmitting the requested set of media streams or the modified set of media streams across the network.

11. The method of claim 10 further comprising
determining capabilities of the playback devices for processing a media stream;
determining whether the capability of each of the playback devices is sufficient to process a requested media stream resulting from the independent transformations; and
if not, determining whether the capability of each of the playback devices is sufficient to process a requested media stream resulting from the dependent transformations.

12. The method of claim 10 further comprising
monitoring available bandwidth of the network;
determining whether the requested set of media streams resulting from the independent transformations is transmissible within the available bandwidth of the network; and
if the requested set of media streams is not transmissible within the available bandwidth of the network, determining the set of dependent transformations such that the modified set of media streams resulting from the set of dependent transformations is transmissible within the available bandwidth of the network.

13. The method of claim 10 further comprising
monitoring available bandwidth of the network;
determining whether the modified set of media streams resulting from the dependent transformations is transmissible within the available bandwidth of the network; and
if the modified set of media streams is not transmissible within the available bandwidth of the network, determining a revised set of dependent transformations such that a revised set of media streams resulting from the revised set of dependent transformations is transmissible within the available bandwidth of the network.

14. The method of claim 10 further comprising transmitting across the network a modified set of media streams resulting from the dependent transformations across the network.

15. The method of claim 10 further comprising storing a modified set of media streams resulting from the dependent transformations as media files on a storage device.

16. The method of claim 10, wherein the second quality level is lesser than the first quality level.

17. The method of claim 10, wherein the quality level is measured in terms of one ore more of the following: a selected format of the media content, a selected bit rate of the media content, and an image resolution of the media content.

18. A computer-readable medium having computer-executable instructions for performing a computer process implementing the method of claim 10.

19. A host computer system for performing transformative processing operations to optimize media content playback across multiple devices, which are connected with the host computer in a network, requesting concurrent playback of media content at a first quality level, the system comprising
one or more media processing units;
a policy engine module that
determines a set of independent transformations of the media content that fulfill requests at the first quality level;
determines whether processing resources of the media processing units are sufficient to perform the independent transformations; and
if the processing resources are sufficient to perform the independent transformations, directs the media processing units to perform the independent transformations to create a requested set of media streams; and
if the processing resources are insufficient to perform the independent transformations, determines a set of dependent transformations that fulfill the requests at a second quality level within limits of the processing resources; and
directs the media processing units to perform the dependent transformations to create a modified set of media streams; and
a network link that communicates with the network and transmits either the requested set of media streams or the modified set of media streams to the multiple devices.

20. The system of claim 19 further comprising
a network monitor module that monitors available bandwidth of the network and passes bandwidth information to the policy engine module; and
wherein the policy engine module further
determines whether the requested set of media streams resulting from the independent transformations is transmissible within the available bandwidth of the network; and
if the requested set of media streams is not transmissible within the available bandwidth of the network, determines the set of dependent transformations such that the modified set of media streams resulting from the set of dependent transformations is transmissible within the available bandwidth of the network; and
determines whether the modified set of media streams resulting from the dependent transformations is transmissible within the available bandwidth of the network; and
if the modified set of media streams is not transmissible within the available bandwidth of the network, determining a revised set of dependent transformations such that a revised set of media streams resulting from the revised set of dependent transformations is transmissable within the available bandwidth of the network.

21. The system of claim 20 further comprising a storage device that stores an output stream of transformed media content processed by the media processing units.
